(19) United States
(12) Patent Application Publication
(10) Pub. No.: US 2012/0292295 A1
(43) Pub. Date: Nov. 22, 2012

(54) LASER ADDITIVE

(75) Inventors: Gerhard Edler, Trebur (DE); Helge Bettina Kniess, Rossdorf (DE); Klaus Bernhardt, Gross-Umstadt (DE)

(73) Assignee: MERCK PATENT GESELLSCHAFT MIT BESCHRANKTER HAFTUNG, Darmstadt (DE)

(21) Appl. No.: 13/521,863

(22) PCT Filed: Dec. 17, 2010
(86) PCT No.: PCT/EP2010/007741

§ 371 Date: Jul. 12, 2012

(30) Foreign Application Priority Data
Jan. 14, 2010 (DE) 10 2010 004 743.0

(51) Int. Cl. B23K 26/00; C08K 3/34; C08K 3/30; C08K 3/22; C08K 3/04

(52) U.S. Cl. 219/121.6; 106/450; 106/475; 106/461; 524/413; 524/423; 524/451; 524/449; 524/493

(57) ABSTRACT

The present invention relates to a laser additive in the form of particles comprising a white core and a shell which comprises elemental carbon, to a process for the preparation thereof, and to the use of a laser additive of this type in organic polymers, in particular in plastics, coatings, automobile paints, powder coatings, printing inks, paper coatings and papermaking stocks for the production of durable pale laser markings, preferably on a dark background

The present invention relates to a laser additive in the form of particles which comprise a core comprising white particles and a shell which comprises elemental carbon, to a process for the preparation thereof, and to the use thereof for the laser marking of black, grey or coloured organic polymers, in particular plastics, coatings, automobile paints, powder coatings, printing inks, paper coatings and papermaking stocks.

The labelling of commercial products by means of laser radiation has now become standard technology in virtually all branches of industry. Thus, for example, production data, batch numbers, use-by dates, bar codes, company logos, serial numbers, etc., frequently have to be applied to plastics or plastic films.

The contrast necessary for labelling is preferably generated by the following processes:

1. Removal of Layers of Different Colour

It is disadvantageous that this is a very complex process which can only be used to a limited extent.

2. Carbonisation of an Organic Matrix

This is currently the most frequently employed process. The carbonisation is effected here either by absorption of the laser radiation in the organic matrix itself or by absorption by added absorbers. In both cases, the carbonisation of the polymer material is effected by a brief heat shock which burns the surrounding matrix. The capacity of the matrix to form carbon to an adequate extent on burning is of crucial importance for the marking result here. Thus, the polymer employed or the matrix formulation has a considerable effect on the marking result. This dependence generally results in extensive preliminary experiments in order to determine a marking result which is adequate for the particular application. In the case of changes in the composition and in many cases also even in the case of variations in the raw-material quality, the suitable inscription parameters always have to be re-determined.

3. Colour Change of Added Pigments

In order to avoid the above-mentioned dependence, it has already been attempted for some time to develop pigments or additives which themselves carry out a colour change (mark intrinsically) on laser bombardment. Such additives generate a mark virtually independently of the surrounding matrix. They can therefore be employed in all plastics. Even in thin layers, such as coatings, paints and prints, marks are possible without significantly damaging the layers.

In particular, the first two of the methods described above are, however, only suitable for the application of black or dark markings to a pale or pale-coloured background. However, applications for laser marking in which white or pale inscriptions on a coloured, grey or black background are desired, for example for computer keyboards, are also known. Such markings should have high resistance to mechanical influences, in particular should be abrasion-resistant, and should retain their pale, preferably white, colouring over a long period with as little change as possible.

For these purposes, dark to black additives which are decolorised, i.e. mark intrinsically, through the action of high-energy laser radiation are generally added to dark or dark-coloured plastics. However, it has been found that the simple removal of the colour on the marked areas often only results in low contrast with the coloured to black surroundings, since the areas subjected to the laser irradiation are generally not large and in addition complete decolourisation frequently cannot be achieved by the laser bombardment.

It has therefore proven advantageous if a pale foam formation which considerably improves the contrast between the area subjected to the laser radiation and the surrounding surface can also be achieved within the marking by the laser bombardment at the same time as the decolourisation of the additives or instead of this. This method enables the production of laser markings which are virtually white.

However, the laser markings described above have the disadvantage that the foam formation within the marking frequently results in a raised surface and in addition inevitably has a certain porosity. On mechanical loading of the marking, for example on use of a computer keyboard which is marked white on black, a constant pressure is exerted on the marked areas over a long period. This pressure compresses the porous foam, in particular if it is raised above the remainder of the unmarked keyboard surface, which results in a considerable reduction in the contrast of the laser marking and at the same time in increased wear of the marking on the keyboard surface.

There therefore continues to be a demand for laser additives which result, in particular on coloured, grey or black backgrounds, in a pale to white marking by laser bombardment which remains unchanged over a long period, even under mechanical load.

The object of the present invention is therefore to find an additive for laser marking which, under the action of laser light in the polymer doped therewith, gives very good marking results, in particular high-contrast and sharp pale to white markings on a dark background, results in mechanically resistant laser markings and can be prepared in a simple manner on an industrial scale.

The object of the present invention is likewise to provide a process for the preparation of a laser additive of this type.

A further object of the invention consists in indicating the use of a laser additive of this type.

It has now been found that particles which consist of a white core and a preferably black or grey shell which can be decolourised by laser irradiation are highly suitable as marking additives for the laser marking of plastics.

The present invention relates to a laser additive in the form of particles which comprise a core comprising white particles and a shell, where the core consists of one or more particles, has a size of at least 100 nm and is chemically stable to the action of directed high-energy radiation, and where the shell comprises elemental carbon.

The present invention likewise relates to a process for the preparation of the laser additive according to the invention in which white particles, which are in the form of individual particles or in the form of agglomerates comprising a plurality of particles and the individual particles or agglomerates have a size of at least 100 nm, are provided with a shell which comprises elemental carbon, and in which the white particles are chemically stable to the action of directed high-energy radiation.

The present invention also relates to the use of the laser additive according to the invention as additive for the laser marking of black, grey or coloured organic polymer systems, in particular in plastics, plastic films, coatings, automobile paints, powder coatings, printing inks, paper coatings and papermaking stocks.

The invention furthermore also relates to the organic polymer systems which comprise the laser additive according to the invention.

Under the action of laser light, the polymer system doped with the laser additive according to the invention exhibits a pale to white marking having high contrast and pronounced edge sharpness on a black, dark or coloured background.

The laser additive according to the invention is in the form of finely divided particles, preferably in the form of a powder. In this form, it can easily be incorporated into the respective polymeric application medium.

The shape and size of the powder particles are not particularly crucial here. In general, the particles are spherical, egg-shaped, lenticular or cylindrical. The shape is determined by the shape of the white particles employed as core material and the subsequent sheathing process. Depending on the sheathing material and the layer thickness of the sheath, irregular, but frequently virtually spherical particles of different size are obtained. The size of the individual particles can vary greatly here and is generally in the range from 0.2 to 250 μm. A narrow particle-size distribution is advantageous, but not necessary.

A particle of the laser additive according to the invention is composed of a core and a shell surrounding the core. The sheathing of the core does not have to be complete, it is sufficient for the predominant part of the surface of the core to be surrounded by the shell. In the case where only a relatively small part of the surface of the core (<50%) is surrounded by the shell, the laser additive would be visible in the application medium, depending on the total particle size, which is generally undesired. It is therefore preferred for >50% of the surface of the core to be covered by the shell.

The core of the laser additive according to the invention consists of one or more white particles and has a size of at least 100 nm. If the core consists of a plurality of white particles, these are in the form of an agglomerate which has a total size of at least 100 nm. It goes without saying that the primary particle size of the particles which form the agglomerate can be less than 100 nm; it is preferably in the range from 10 to 50 nm. The size of the core is assumed to be the length of the largest axis of the core, the primary particle size is assumed to be the length of the largest axis of the primary particles.

White particles in the sense of the present invention are particles which have virtually no spectral absorption in the wavelength range from 380 nm to 780 nm and reflect the incident light at these wavelengths in all directions. A sample of the white particles is considered to be white in the sense of the invention if a flat powder bed applied to a flat surface has such a high reflection of incident visible light, measured using a conventional colorimeter under daylight, that it has, measured in the Hunter L,a,b system, a luminance value L of >50 to 100, but a and b values in the region of the achromatic point, i.e. of less than 10, in particular less than 7. Such colour values are usually perceived as white by the human eye. It goes without saying that the actual sample deviates from an ideally white sample. However, a particle or an agglomerate having a size of at least 100 nm is regarded as white in the sense of the present invention if an observer having normal visual acuity perceives a pigment bed comprising these particles or agglomerates as white without a comparative sample.

By contrast, adequate whiteness cannot be obtained in the case of the use intended in accordance with the invention with individual particles or agglomerates comprising materials which do not absorb in the visible wavelength region and have sizes of less than 100 nm.

The hiding power of the core particles increases with increasing size of the core. In general, the size of the core is in the range from 0.1 to 200 μm. In order to achieve a very high-contrast marking having particularly good edge sharpness, cores having a size of 0.2 to 100 μm are preferred.

The shape of the individual particles or agglomerates which form the core of the laser additive according to the invention plays only a secondary role. In principle, the cores can have all known particle shapes, for example flakes, spheres, fibres, cubes, rods, cuboids or can be in the form of approximately isotropic granules of irregular shape. Preference is given to isotropic shapes, such as spheres or cubes, or irregularly shaped granules. The agglomerates comprising a plurality of particles are frequently in the form of irregular heaps of particles.

Suitable white particles in the sense of the present invention are finely divided materials which are chemically stable under the action of directed high-energy radiation, irrespective of the medium surrounding them. For the purposes of the present invention, this is taken to mean that the materials suitable for use as white particles do not change, at least optically, under the action of directed high-energy radiation, i.e. retain their white coloration, but preferably do not undergo any chemical change, irrespective of the medium surrounding them. These include, for example, conventional white pigments or also white fillers.

However, it should be emphasised that the white pigment most frequently employed, for example, for paints, namely titanium dioxide, is not suitable since it can be reduced under the action of directed high-energy radiation and under certain prerequisites (reducing conditions) to suboxides which have a blue to grey colour and are thus no longer white.

For this reason, the core particles employed for the laser additive according to the invention are white pigments or white fillers of the corresponding size order which are not reduced to coloured compounds, in particular coloured oxides, under the action of directed high-energy radiation, irrespective of the medium surrounding them.

Suitable materials for the cores are preferably zirconium oxide, silicon dioxide, barium sulfate (barytes), kaolin or talc, in each case in the form of individual particles or agglomerates having a minimum size of 100 nm. Particular preference is given to kaolin, talc and barium sulfate.

Directed high-energy radiation in the sense of the present invention is taken to mean the radiation of conventional lasers, as described below. The radiation generated by the lasers is monochromatic, virtually parallel, coherent over long distances and usually bundled. The wavelengths of the laser radiation are usually between 157 nm and 10.6 μm.

The shell surrounding the core comprises elemental carbon. This is in the form of carbon black or in the form of black pigment. All forms of technical-grade carbon blacks or colour blacks having particle sizes of 1 to 100 nm which can be employed in powdered form or in the form of aqueous carbon-black dispersions, for example the carbon blacks from Evonik known under the trade names Derussol®, Colour Black FW or Colour Black S, in particular Colour Black FW 1, Derussol® A and Derussol® N 25/L, are suitable.

Although the elemental carbon can be bonded to the surface of the core particles via adhesion forces by simple mixing, it is advantageous for the shell surrounding the core also to comprise, in addition to the elemental carbon, an organic polymer, with the aid of which the elemental carbon can be applied very homogeneously to the surface of the core particles and at the same time is incorporated in this sheath.

Suitable organic polymers here are those which are not carbonised by high-energy radiation. The organic polymer is preferably selected from the group of the amino resins, in particular from the group melamine resins, urea resins, urea-formaldehyde resins, melamine-formaldehyde resins, urea/melamine mixtures or polyamides. These, or the starting materials for the preparation of the polymers, can be mixed with the elemental carbon in simple processes and applied to the surface of the cores in the form of polymers.

The elemental carbon is present in the shell of the laser additive according to the invention in a proportion of 0.1 to 50% by weight, preferably 0.1 to 20% by weight, based on the weight of the shell.

In principle, no further additives apart from the materials already described are necessary for the preparation of the laser additive according to the invention.

In a preferred embodiment, however, the laser additive according to the invention may also, besides the core particles, the elemental carbon and an organic polymer, additionally comprise one or more protective colloids. These prevent the caking together of a relatively large number of core particles if their particle size as individual particles is already sufficient for the preparation of a laser additive according to the invention.

Suitable protective colloids are the classes of compound known to the person skilled in the art for such purposes, in particular water-soluble polymers, such as partially hydrolysed polyvinyl acetate, polyvinyl alcohol, polyvinyl pyrrolidone, cellulose ethers (Tylose), such as, for example, methylcellulose, hydroxyethylcellulose and hydroxypropylmethylcellulose, polyacrylates, starch, proteins, alginates, pectins or gelatine. Particular preference is given to cellulose ethers, in particular hydroxyethylcellulose.

The protective colloids are added in small amounts of 0.01 to 5%, preferably 0.1 to 2%, based on the weight of the preparation used for the preparation of the laser additive according to the invention. The size of the cores can be set in a targeted manner here via the amount of protective colloids employed and any surfactants additionally present. The principle that a larger amount of protective colloids results in a reduced size of the cores basically applies here.

The size, particle size or primary particle size in the sense of the present invention is in each case regarded as being the length of the greatest axis of the respective particles (cores, primary particles or particulate laser additive according to the invention). This size can in principle be determined using any method for particle-size determination that is familiar to the person skilled in the art. The particle-size determination can be carried out in a simple manner, depending on the size of the laser additives, for example by direct observation and measurement of a number of individual particles in high-resolution light microscopes, but better in electron microscopes, such as the scanning electron microscope (SEM) or the high-resolution electron microscope (HRTEM), but also in the atomic force microscope (AFM), the latter in each case with appropriate image analysis software. The determination of the particle size can advantageously also be carried out using measuring instruments (for example Malvern Mastersizer 2000, APA200, Malvern Instruments Ltd., UK), which operate on the principle of laser diffraction. Using these measuring instruments, both the particle size and also the particle-size distribution in the volume can be determined from a pigment suspension in a standard method (SOP). The last-mentioned measurement method is preferred in accordance with the present invention.

The laser additive according to the invention is preferably in the form of a grey or black powder. The core and shell have a weight ratio of 20:1 to 1:1, preferably 8:1 to 2:1. Particular preference is given to laser additives according to the invention whose core consists of kaolin, talc or barium sulfate in the said size order and whose shell comprises a melamine resin or a urea-formaldehyde resin, in each case in combination with carbon black.

If the particulate laser additive according to the invention is introduced into organic polymers or polymer systems which have a dark-coloured, grey or black inherent colour, and if these are subjected to the action of high-energy radiation (laser bombardment), the laser additive shell comprising the elemental carbon is decolourised. Although this likewise occurs on use of particulate carbon black as laser absorber with formation of CO₂, this arises in the shell surrounding the core of the laser additive, where it is in extremely fine-pored form and in close proximity to the particulate core of the laser additive. Since the organic polymer preferably used in the shell does not carbonise under the conditions of the laser irradiation, the shell as a whole is decolourised. At the same time, the scattering of incident light which is latently present due to the white core is activated, the white core becomes visible at the marked places and forms a high contrast with the surrounding (dark) plastic, if appropriate in interaction with the shell surrounding the core. Not only high-contrast pale to white markings on a dark background, but also markings having a pronounced edge sharpness are obtained. Foam formation at the surface of the marked article hardly occurs at all. For this reason, the markings achieved are extremely mechanically stable and lose neither contrast nor clarity with increasing mechanical load.

The present invention furthermore relates to a process for the preparation of the laser additive according to the invention in the form of particles, in which white particles having a size of at least 100 nm, which are in the form of individual particles or agglomerates and are chemically stable to the action of high-energy radiation, are provided with a shell which comprises elemental carbon.

A shell which, besides the elemental carbon, also comprises an organic polymer is particularly preferably applied to the white particles forming the core.

The polymer here is selected, in particular, from the group of the amino resins, in particular from the group melamine resins, urea resins, ureaformaldehyde resins, melamine-formaldehyde resins, urea/melamine mixtures or polyamides.

If these polymers are selected, the coating of the white particles which form the core of the laser additive according to the invention with a polymer shell comprising elemental carbon is carried out by wet-chemical acid-catalysed polycondensation of an aqueous preparation, preferably solution, of an amino resin in the presence of dispersed core particles and elemental carbon, preferably in the form of likewise dispersed carbon blacks. The condensate of the amino resin is insoluble in water and precipitates on the surface of the core together with the elemental carbon.

Further materials preferably employed have already been described above. Reference is made to them here.

In the process according to the invention, the materials mentioned above as cores, which are in the form of white particles, are mixed intimately with elemental carbon and the aqueous preparation of an organic polymer and optionally additional additives at a temperature of at least 50° C. with addition of an acid, cooled and dried. Both dispersions and solutions of the organic polymers can be employed as aqueous preparation.

By adjusting the pH to values between 1 and 7, preferably between 2 and 5, a polymer shell comprising elemental carbon is deposited on the white particles which form the core. The reaction time is usually between 10 and 60 minutes. After cooling of the reaction product, the batch is dried at temperatures between 100 and 250° C. over a period of 2 to 20 hours. The powder obtained may additionally be prepared by grinding and/or sieving operations. A grey to black powder is obtained.

The present invention also relates to the use of the laser additive described above for the laser marking of organic polymers, in particular dark-coloured, grey or black plastics.

In particular, the present invention also relates to a plastic, in particular to a dark-coloured, grey or black, preferably to a grey or black, plastic which comprises the laser additive acoording to the invention.

Through the addition of the laser additives according to the invention, in particular in concentrations of 0.1 to 30% by weight, preferably 0.5 to 20% by weight and very particularly preferably 1 to 10% by weight, based on the, organic polymer or polymer system to be marked, significantly higher contrast is achieved in the laser marking of polymers than with the commercially available (foaming) laser absorbers at comparable concentrations. The said concentrations are not solely dependent on the desired contrast, but also on the layer thickness of the use medium. Thus, significantly higher concentrations are necessary in print and coating applications than in plastics in order to provide the laser beam with a sufficient number of pigment particles.

The concentration of the laser pigment according to the invention in polymers or in polymer systems, preferably in thermoplastics, thermosets or elastomers, is, however, also dependent on the polymer material employed. The low proportion of laser pigment changes the polymer system insignificantly and does not affect its processability.

Furthermore, colorants which allow colour variations of any type, in particular the dark-coloured, grey or black coloration of the polymer, and at the same time ensure the visibility of the laser marking can be added to the polymers. Suitable colorants are, in particular, coloured metal-oxide pigments and organic pigments and dyes which do not decompose during the laser marking and do not react under laser light.

However, very particular preference is given to colorants which colour the polymer grey or black, since the marking which can be achieved with the laser additive according to the invention under the action of a laser beam has particularly high contrast and sharp edges on a dark, grey or black background. Although a weak pale to white laser marking can likewise be obtained on addition of the laser additive according to the invention to white or pale plastics, the achievable contrast is, however, only low. In addition, the addition of the grey or black laser additive, even if it is only employed in small amounts, would possibly falsify the original colouring of the polymer. By contrast, the use of the laser additive according to the invention in dark-coloured, grey or black polymer systems, even in relatively large amounts, is possible, where it results in the expected high-contrast pale marking.

Suitable polymeric materials for the laser marking are, in particular, all known plastics, in particular thermoplastics, furthermore thermosets and elastomers, as described, for example, in Ullmann, Vol. 15, pp. 457 ff., Verlag VCH. Suitable polymers are, for example, polyethylene, polypropylene, polyamides, polyesters, polyester-esters, polyether-esters, polyphenylene ether, polyacetal, polyurethane, polybutylene terephthalate (PBT), polymethyl methacrylate, polyvinyl acetal, polystyrene, acrylonitrile-buta-diene-styrene (ABS), acrylonitrile-styrene-acrylate (ASA), polycarbonate, polyether sulfones and polyether ketones, and copolymers, mixtures and/or polymer blends thereof, such as, for example, PC/ABS, MABS.

The laser additive according to the invention is incorporated into the polymer to be marked, preferably a plastic or plastic film, or a coating, for example a paint, a paper coating or a powder coating, an automobile paint or a colour print, by mixing the polymer granules, the surface coating, the printing ink or the paper stock with the laser additive and optionally deforming the mixture under the action of heat. The paper stocks, printing inks and surface coatings are then processed further in a conventional manner. The laser additive can be added to the polymer simultaneously or successively. Adhesives, organic polymer-compatible solvents, stabilisers and/or surfactants which are temperature-stable under the working conditions can optionally be added to the polymer, preferably plastic granules, during incorporation of the laser additive.

Plastic granules doped with the laser additive are generally prepared by initially introducing the plastic granules in a suitable mixer, wetting them with any additives and then adding and incorporating the laser additive. The polymer is generally pigmented via a colour concentrate (masterbatch) or compound. The resultant mixture can then be processed directly in an extruder or injection-moulding machine. The mouldings formed on processing exhibit a very homogeneous distribution of the laser pigment. The laser marking is subsequently carried out using a suitable laser.

The laser inscription is carried out by introducing the sample into the ray path of a pulsed laser, preferably an Nd:YAG laser. Furthermore, inscription using an excimer laser, for example via a mask technique, is possible. However, the desired results can also be achieved using other conventional types of laser which have a wavelength in a region of high absorption by the additive used. The mark obtained is determined by the irradiation time (or number of pulses in the case of pulsed lasers) and irradiation power of the laser and the plastic system used. The power of the lasers used depends on the respective application and can readily be determined by the person skilled in the art in each individual case.

The laser used generally has a wavelength in the range from 157 nm to 10.6 μm, preferably in the range from 532 nm to 10.6 μm. For example, CO₂ lasers (10.6 μm) and Nd:YAG lasers (1064 or 532 nm) or pulsed UV lasers may be mentioned here. The excimer lasers have the following wavelengths: F₂ excimer laser (157 nm), ArF excimer laser (193 nm), KrCl excimer laser (222 nm), KrF excimer laser (248 nm), XeCl excimer laser (308 nm), XeF excimer laser (351 nm), frequency-multiplied Nd:YAG lasers having wavelengths of 355 nm (frequency-tripled) or 265 nm (frequency-quadrupled). Particular preference is given to the use of Nd:YAG lasers (1064 or 532 nm) and CO₂ lasers. The energy densities of the lasers employed are generally in the range from 0.3 mJ/cm² to 50 J/cm², preferably 0.3 mJ/cm² to 10 J/cm². On use of pulsed lasers, the pulse frequency is generally in the range from 1 to 60 kHz. Corresponding lasers which can be employed in the process according to the invention are commercially available.

The polymer doped with the laser additive according to the invention can be used in all areas where conventional printing processes were hitherto employed for the inscription of plastics and plastic films. For example, moulding compositions, semifinished products and finished parts made from the polymer according to the invention can be used in the electrical, electronics and motor vehicle industries. The labelling and inscription of, for example, cables, lines, decorative strips or functional parts in the heating, ventilation and cooling sectors or keyboards, switches, plugs, levers and handles which consist of the polymer doped in accordance with the invention can be marked with the aid of laser light, even in poorly accessible areas. Furthermore, the polymer system according to the invention can be employed for packaging in the foods sector or in the toys sector. Marks on packaging are distinguished by the fact that they are wipe-resistant and in particular mechanically stable, for example scratch-resistant, stable during subsequent sterilisation processes and can be applied hygienically during the marking process. Furthermore, plastic corks, for example for wine bottles, can be inscribed.

Complete label images can be applied in a durable manner to the packaging for a re-usable system. Furthermore, the polymer system according to the invention is used in medical technology, for example in the marking of Petri dishes, microtitre plates, disposable syringes, ampoules, sample containers, supply tubes and medical collection bags or storage bags.

A further important area of application for laser inscription is plastic marks for the individual labelling of animals, so-called cattle tags or ear marks.

The information which belongs specifically to the animal is stored via a bar code system. This information can be called up again when needed with the aid of a scanner. The inscription must be very durable since the marks in some cases remain on the animals for a number of years.

The laser marking of moulding compositions, semifinished products and finished parts which consist of polymers doped with the laser additive according to the invention is thus possible. Particular preference is given to the use of the laser additive according to the invention for the laser marking of grey, black or dark-coloured plastic parts which are subjected to high mechanical load. A durable white or pale marking on a dark or black background can be achieved here. In addition, the laser additive according to the invention can optionally be introduced into variously coloured dark plastic compositions without falsifying the optical appearance thereof (no fogging).

On use of the laser additive according to the invention in plastics, virtually no foaming of the laser additive occurs at the surface of the plastic on laser bombardment, meaning that pale laser marking obtained has virtually no porosity at the plastic surface and can thus be neither scratched off nor compressed on mechanical load. The pale marking achievable is therefore mechanically stable and durable.

The following examples are intended to explain the invention, but without limiting it. The per cent data indicated are per cent by weight.

### Example 1

50 g of kaolin having a particle size of D₉₀=22 μm (determined using a Malvern Instruments Ltd. Mastersizer 2000 under standard conditions) are made into a paste in 50 g of water 25 g of melamine-formaldehyde resin (Madurit MW 830, Ineos, 75% solution) and 1 g of carbon black (Colour Black FW 1 from Evonik) are stirred into the kaolin suspension. 50 g of a 0.3% tylose solution (Tylose H2O from SE Tylose GmbH & Co. KG) are added, and the batch is dispersed in a bead mill (bead mill attachment for Getzmann “Dispermat” dissolver). The ready-dispersed batch is subsequently warmed to 70° C. and adjusted to pH 3.5 using about 26 ml of a 1 molar hydrochloric acid with stirring. After a reaction time of 30 min, the batch is allowed to cool. The batch is subsequently filtered through a suction filter and dried overnight at 200° C. The material obtained in this way is ground and sieved (sieve having a mesh width of 40 rim), giving a black powder having a particle size D₉₀=31 μm determined using a Malvern Instruments Ltd. Mastersizer 2000 under standard conditions.

The powder obtained is incorporated in a proportion of 2% into polypropylene provided with a black dye, and the resultant compound is shaped into test plates measuring 6×9 cm in an injection-moulding machine.

A white marking in the form of writing is applied to the test plates using an Nd:YAG laser at a pulse frequency of 1-20 kHz and a speed of 300 mm/s. On intensive pressure loading of the marked test area (rubbing with a metallic article over 120 minutes), the surface of the plastic is smoothed, whereas the white marking exhibits no significant change.

### Comparative Example 1

Carbon black (Colour Black FW 1) is incorporated in a proportion of 2% into black polypropylene analogously to Example 1 and shaped into test plates in the dimensions indicated in Example 1 in an injection-moulding machine.

White writing is written into the test plates using an Nd:YAG laser working at a pulse frequency and laser speed analogous to Example 1. The marking obtained exhibits a contrast which is comparable to the marking in accordance with Example 1. Under the pressure load mentioned in Example 1, the whiteness of the marking changes to a brownish yellow within a short time (30 minutes).

### Example 2

50 g of kaolin (product from Merck KGaA) having a particle size of D₉₀=22 μm (determined using a Malvern Instruments Ltd. Mastersizer 2000 under standard conditions,) are dispersed with 25 g of urea-formaldehyde resin (Kaurit liquid, 50%, product from BASF), 4 g of an aqueous carbon-black dispersion (Derussol® N25/L from Evonik, carbon-black content 25%) and 50 g of a 0.3% tylose solution (0.15 g of Tylose H2O, product from SE Tylose GmbH & Co., dissolved in 49.85 g of water at 60° C.) in a dissolver. The ready-dispersed batch is subsequently warmed to 70° C., and a pH of 3 to 4 is established by addition of a 10% oxalic acid with stirring. After a _{reaction time of} 60 min, the batch is allowed to cool. The batch is washed with deionised water, subsequently filtered through a suction filter and dried overnight at 180° C. The material obtained in this way is ground and sieved (sieve having a mesh width of 40 μm), giving a black powder having a particle size D₉₀=28 μm determined using a Malvern Instruments Ltd. Master-sizer 2000 under standard conditions.

The powder obtained is incorporated in a proportion of 2% into polypropylene provided with a black dye, and the resultant compound is shaped into test plates measuring 6×9 cm in an injection-moulding machine. A white marking in the form of writing is applied to the test plates using an Nd:YAG laser at a pulse frequency of 1-20 kHz and a speed of 300 mm/s. On intensive pressure loading of the marked test area (rubbing with a metallic article over 120 minutes), the surface of the plastic is smoothed, whereas the white marking exhibits no significant change.

1. Particles comprising a core comprising one or more white particles, where the core has a size of at least 100 nm and is chemically stable to the action of directed high-energy radiation, and a shell which comprises elemental carbon.

2. Particles according to claim 1, characterised in that the white particles consist of a white pigment or a white filler.

3. Particles according to claim 1, characterised in that the white particles consist of zirconium dioxide, silicon dioxide, barium sulfate, kaolin or talc.

4. Particles according to claim 1, characterised in that the core has a size in the range from 0.1 to 200 μm.

5. Particles according to claim 4, characterised in that the core has a size in the range from 0.2 to 100 μm.

6. Particles according to claim 1, characterised in that the shell additionally comprises an organic polymer which is not carbonised by directed high-energy radiation.

7. Particles according to claim 6, characterised in that the polymer is selected from the group melamine resins, urea resins, urea-formaldehyde resins, melamine-formaldehyde resins, urea/melamine mixtures or polyamides.

8. Particles according to claim 1, characterised in that the elemental carbon is in the form of carbon black or in the form of black pigment.

9. Process for the production of particles according to claim 1, characterised in that white particles having a size of at least 100 nm, which are in the form of individual particles or agglomerates and are chemically stable to the action of directed high-energy radiation, are provided with a shell which comprises elemental carbon.

10. Process according to claim 9, characterised in that the white particles are provided with a shell which, besides the elemental carbon, comprises an organic polymer.

11. Process according to claim 9, characterised in that the polymer is selected from the group melamine resins, urea resins, urea-formaldehyde resins, melamine-formaldehyde resins, urea/melamine mixtures or polyamides.

12. Process according to claim 1, characterised in that the white particles are mixed intimately with elemental carbon and an aqueous preparation of an organic polymer and optionally additional additives at a temperature of at least 50° C. with addition of an acid, cooled and dried.

13. A method for the laser marking of plastics which comprises incorporating particles of claim 1 in said plastics.

14. A method of claim 13 for the production of a non-foaming marking at the surface of the marked plastic.

15. Plastic comprising particles according to claim 1.
